(19) United States
(12) Patent Application Publication
(10) Pub. No.: US 2026/0161525 A1
(43) Pub. Date: Jun. 11, 2026

(54) COMBINED CHANGE-POINT ANALYZER FOR DATABASE SYSTEMS

(71) Applicant: SAP SE, Walldorf (DE)

(72) Inventors: Zhan Lyu, Xi’an (CN); Thomas Bach, Rauenberg (DE); Yong Li, Xi’an (CN); Nguyen Minh Le, Xi’an (CN); Lars Hoemke, Boehl-Iggelheim (DE)

(73) Assignee: SAP SE, Walldorf (DE)

(21) Appl. No.: 18/970,684

(22) Filed: Dec. 5, 2024

(51) Int. Cl. G06F 11/34; G06F 16/21

(52) U.S. Cl. CPC G06F 11/3452; G06F 11/3428; G06F 16/21

(57) ABSTRACT

A combined change-point analyzer automatically detects change points in time series data by sequentially applying a Bayesian model and a Pruned Exact Linear Time (PELT) model. After a pre-processing stage, the Bayesian model identifies potential change points in the time series data by determining respective Bayes factors for positions in the time series data and outputs the potential change points to the PELT model. The PELT model determines respective costs of the pre-change points using a penalized cost function and minimizes the penalized cost function over the time series data to determine final change points from among the potential change points. A feedback loop system can be implemented in which the respective final change points are manually verified as confirmed, modified, or pending change points or removed. User input received during the manual verification process can be stored and used for model parameter optimization to enhance accuracy and efficiency.

### FIELD

The field generally relates to identifying performance regressions in database systems.

### BACKGROUND

Performance testing in large-scale database systems can be a labor-intensive and error-prone process. For example, performance testing in large-scale database systems can require the analysis of thousands of metrics, such as Central Processing Unit (CPU) time and elapsed time, to identify performance regressions after system updates.

The traditional manual approach to this analysis is time-consuming, inefficient, and susceptible to human error, leading to delays in detection of critical performance issues. This can pose a significant challenge in maintaining the reliability and efficiency of a large-scale database system, especially as the volume of data and complexity of operations in such systems continues to grow.

### BRIEF DESCRIPTION OF THE DRAWINGS

FIG. 1 is a block diagram of an example system implementing a combined change-point analyzer for database systems.

FIG. 2 is a block diagram of an example Bayesian technique for determining pre-change points.

FIG. 3 is a block diagram of an example PELT technique for determining change points.

FIG. 4 is a flowchart of an example method for change point detection.

FIG. 5 is a block diagram of an example feedback loop system that incorporates a combined change-point analyzer.

FIG. 6 is a graph of example change points detected by applying Bayesian model.

FIG. 7 is a graph of example change points detected by applying a PELT model.

FIG. 8 is a graph of performance test results obtained for various change point detection techniques performed on a public dataset with zero as the default change point.

FIG. 9 is a graph of performance test results obtained for various change point detection techniques performed on a dataset from a large-scale database system with zero as the default change point.

FIG. 10 is a graph of performance test results obtained for various change point detection techniques performed on a public dataset without restricting the default change point to zero.

FIG. 11 is a graph of performance test results obtained for various change point detection techniques performed on a dataset from a large-scale database system without restricting the default change point to zero.

FIG. 12 is a graph of CPU time and elapsed time during performance tests for various change point detection techniques.

FIG. 13 is a block diagram of an example computing system in which described embodiments can be implemented.

FIG. 14 is a block diagram of an example cloud computing environment that can be used in conjunction with the technologies described herein.

### DETAILED DESCRIPTION

### Example 1—Overview

In various domains, analyzing time series data (e.g., data sequences capturing system behavior over time) has become increasingly crucial. These time series are subject to shifts due to internal and external triggers, necessitating the detection of such abrupt changes, known as Change Point Detection (CPD). This field, while related to segmentation, edge, event, and anomaly detection, focuses on identifying and modeling changes. Performance testing is an important part of the lifecycle of database systems as it ensures robustness and efficiency.

Performance testing of database systems has traditionally been a manual and labor-intensive process, fraught with potential human error and the inefficiencies of prolonged testing cycles. Identifying performance regressions, or decreases in database performance after updates, is challenging due to the complexity of operations and subtle shifts in metrics. Manual practices consume resources, risking oversight and delays in database system deployment.

To address at least some of these issues, techniques are described herein for automatically detecting change points in time series data using a combined change-point analyzer which includes a Bayesian model and a Pruned Exact Linear Time (PELT) model. The disclosed techniques uniquely integrate Bayesian inference with PELT techniques to enhance the detection of change points, thereby facilitating identification of performance regressions in large-scale database systems. The combined methodology of the disclosed techniques increases precision and efficiency in identifying performance issues, thereby reducing reliance on manual intervention and accelerating the testing process. The disclosed techniques can alternatively be referred to as Bayesian Initiated PELT Confirmation (BIPEC).

The disclosed techniques address a specific gap in performance regression detection, particularly in large-scale database systems. In particular, the disclosed techniques ensure that genuine performance regressions are accurately identified while minimizing false negatives and unnecessary alarms. This robust detection framework reduces manual intervention and supports a more proactive and flexible system maintenance model. Extensive testing across diverse datasets has demonstrates that the disclosed techniques can expedite testing, enhance reliability, and ensure performance quality of large-scale database systems.

In accordance with the disclosed techniques, a combined change-point analyzer preprocesses data to eliminate noise and outliers, applies a Bayesian model to the time series data to determine one or more potential change points (referred to as pre-change points), and then refines these detections by applying a PELT model to the time series data and the one or more pre-change points to determine one or more change points (e.g., final change points) from among the one or more pre-change points. Applying the PELT model can include determining respective costs of the one or more pre-change points using a penalized cost function, and minimizing the penalized cost function over the time series data. This process can ensure high accuracy in identifying genuine performance regressions in large-scale database environments. The use of Bayesian inference provides a probabilistic analysis framework that identifies pre-change points in time series data, enhancing the precision of performance regression detection. The PELT model is employed to optimize and confirm the detected pre-change points, ensuring efficient and accurate identification with minimal false positives. In some examples, the PELT model includes a Radial Basis Function (RBF) model which can measure the similarity or dissimilarity between data at different positions in a time series.

The disclosed approach expedites performance regression detection and assures that the outcomes are consistent and repeatable, even when the analysis is performed multiple times for the same dataset. Consequently, the combined change-point analyzer is adept at processing complex and extensive datasets, providing enhanced precision and reliability in change point detection in large-scale data environments. The described technologies thus offer considerable improvements over conventional manual techniques for performance regression detection, such as manual techniques which employ a single approach and cannot efficiently handle large datasets or provide real-time analysis.

In addition, techniques are described herein for a feedback loop system which integrates automated change point detection with manual verification to enhance accuracy and efficiency in time series analysis. The feedback loop system can improve the quality and reliability of regression detection by effectively integrating user input with automated processes.

### Example 2—Example Methods for Change Point Detection

Traditional change point detection broadly categorizes methodologies into optimal methods and approximate methods. So-called optimal methods such as OptPelt focus on efficiency, leveraging linear-time complexity and pruning techniques to expedite computation. These methods aspire to accurately determine the most probable set of change points by minimizing a cost function. However, such methods necessitate precise parameter calibration and are inherently sensitive to their initial analytical setup.

Approximate methods such as the Window-sliding technique provide a more intuitive approach. These methods are particularly well-suited to instances where change intervals are predefined, allowing for a straightforward implementation. However, their suitability wanes when faced with data complexity and acoustic clutter, where the exact location of change points is still being determined. Approximate methods are also known to impose substantial computational overhead. One example approximate method is Binary Segmentation (BINSEG), which stands out for its recursive efficiency (especially when the number of change points is undetermined). This method can quickly identify multiple shifts but may overlook closely spaced changes and struggle in noisy environments. Another example approximate method is Bottom-up Segmentation. The Bottom-up Segmentation method exhibits a propensity for detecting subtle changes, beginning with a wide net of potential change points and methodically merging segments. The strength of this method in discerning small-scale shifts is countered by its vulnerability to noise and the potential for high computational load due to its initial detailed segmentation.

The shift from traditional to advanced methods has expanded change point detection techniques, dealing with numerous challenges in large-scale, real-time performance analysis. Some examples of advanced change point detection techniques include Bayesian change-point inference, Bayesian online change point detection (BOCPD), BINSEG, and nonparametric approaches. These advanced techniques provide methods for grouping and detecting change points with improved computational efficiency and without stringent assumptions on data distribution. Another examples advanced change point detection techniques is Wild Binary Segmentation (WBS), which represents a major advance in addressing multiple change point detection with enhanced accuracy and computational feasibility. Ongoing innovation in the field such as the integration of robust Bayesian inference methods for nonstationary streaming data and kernel-based change point analysis offers methods that are both robust and capable of handling complex data with high precision.

However, the inventors herein have recognized that traditional change point detection methods, such as those described above, are inadequate for detecting performance regression in large-scale database systems with complex time series data. For example, even the more advanced traditional change point detection methods often fail to identify shifts with high precision due to the intricate nature of such data streams. In contrast, the disclosed techniques overcome these issues by integrating the probabilistic strengths of Bayesian methods with the swift and precise change-point identification provided by the PELT method. The integration of these methodologies enables the disclosed change-point analyzer to excel in real-time analysis and improve accuracy in analyzing complex time series data. In addition, the disclosed change-point analyzer also performs well with simpler time series data, making it a versatile tool for maintaining database system performance quality and supporting sustainable performance management in large-scale data environments.

### Example 3—Example System Implementing a Combined Change-Point Analyzer

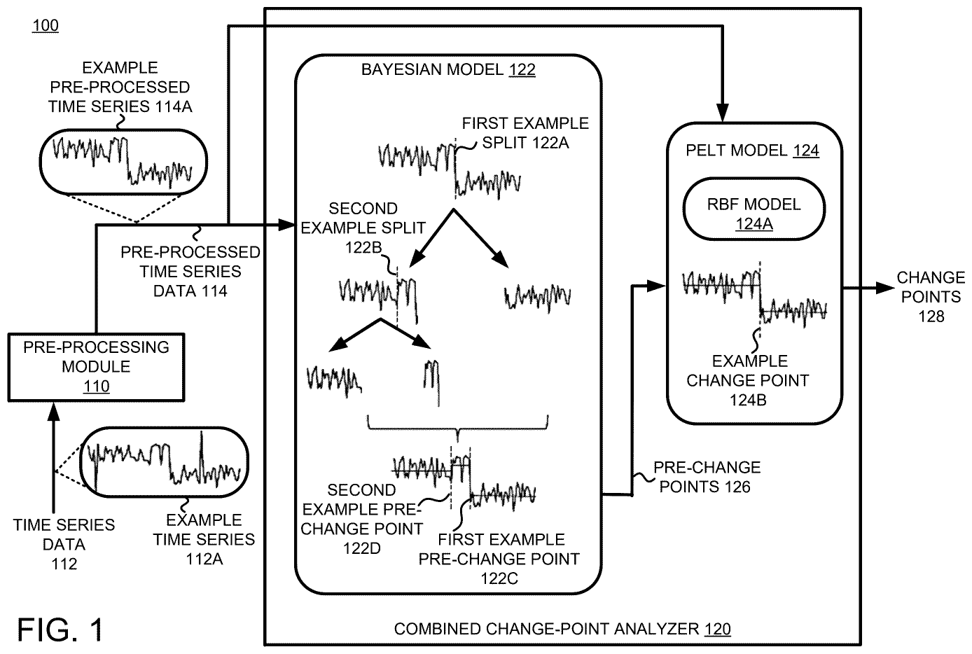

FIG. 1 is a block diagram of an example system 100 implementing a combined change-point analyzer to identify performance regressions. In the example, the system 100 includes a pre-processing module 110 and a combined change-point analyzer 120. System 100 can also include additional components which are not shown in FIG. 1.

As shown, pre-processing module 110 receives time series data 112 as an input. The time series data 112 can include raw (e.g., unprocessed) time series data which includes a sequence of data points collected and ordered chronologically over time. The data points can include measurements or observations recorded at regular or irregular intervals, with each data point being associated with a specific timestamp (alternatively referred to as a time point or position in the time series). A graph of an example time series 112A is depicted for illustrative purposes; in practice, the time series data 112 may include significantly more data than the example time series 112A.

In the example, the time series data 112 (e.g., the raw time series data) is pre-processed by the pre-processing module 110 to generate pre-processed time series data 114. This can include the pre-processing module 110 reducing noise in the raw time series data and removing one or more outlier data points from the raw times series data to prepare the data for subsequent analysis. Outliers in a time series can refer to data points that significantly deviate (e.g., deviate more than a threshold amount) from an expected pattern or trend in the time series. These anomalous values may be caused by measurement errors, rare events, or system malfunctions. Noise in a time series can refer to random fluctuations or variability in the data which do not represent a meaningful pattern or trend. For illustrative purposes, an example pre-processed time series 114A is shown which corresponds to the example time series 112A after it has undergone pre-processing by the pre-processing module 110.

The pre-processed time series data 114 is output by the pre-processing module 110 and provided as an input to the combined change-point analyzer 120, which includes a Bayesian model 122 and a PELT model 124. In the example, after being input to the combined change-point analyzer 120, the pre-processed time series data 114 is input to the Bayesian model 122.

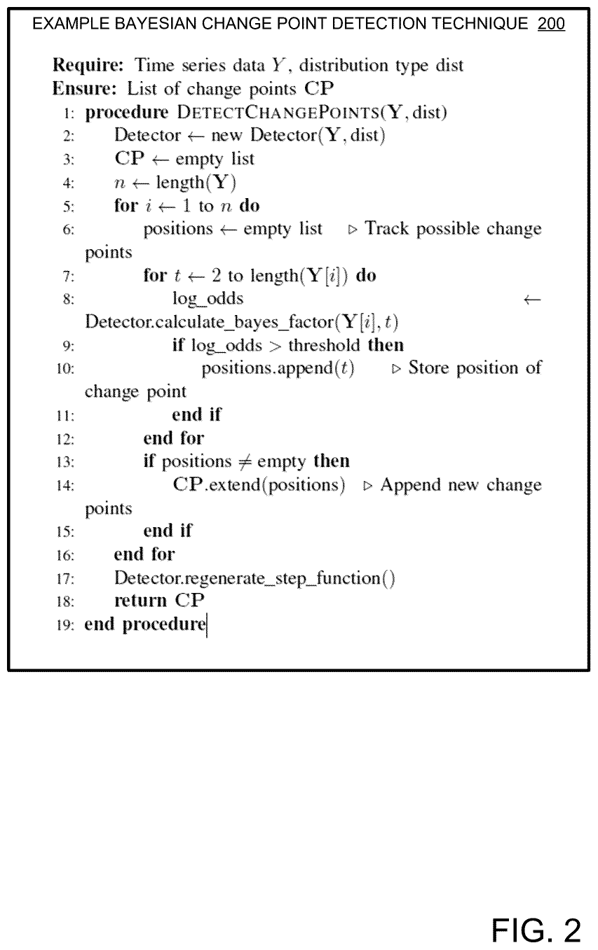

The Bayesian model 122 then performs a Bayesian pre-change point detection technique to determine one or more pre-change points in the pre-processed time series data 114. The determination of the one or more pre-change points can be based at least in part on a distribution type of the pre-processed time series data 114 (e.g., Poisson distribution or Gaussian distribution); the distribution type can be determined automatically by the combined change-point analyzer 120. An example Bayesian pre-change point detection technique 200 is described further below with reference to FIG. 2.

As an overview of the Bayesian pre-change point detection technique, the Bayesian model 122 categorizes the pre-processed time series data 114 into two groups: a group exhibiting potential change points and a group not exhibiting potential change points. To accomplish this, the Bayesian model 122 is applied to the pre-processed time series data 114 to determine respective Bayes factors for positions in the pre-processed time series data 114. The respective Bayes factors for the positions are compared to a predefined threshold, and a subset of the positions which have respective Bayes factors that exceed the predefined threshold is identified based on the comparison. The positions in the subset are designated as pre-change points 126 and can be specified in a list of pre-change points 126 for the pre-processed time series data 114.

An example process of determining two pre-change points in the example pre-processed time series 114A using the Bayesian model 122 is shown for illustrative purposes. In the example, the Bayesian pre-change point detection technique includes determining a position in the example pre-processed time series 114A at which the data has a Bayes factor greater than a threshold, which in turn indicates that the position is a potential change point. A position in a time series can alternatively be referred to as a time point in the time series.

The determined position, designated as a first example split 122A, is depicted as a dashed line in the example. As shown, the technique continues by splitting the example pre-processed time series 114A into two segments at the first example split 122A: a first segment comprising the portion of the example pre-processed time series 114A before the first example split 122A, and a second segment comprising the portion of the example pre-processed time series 114A after the first example split 122A.

The technique continues by determining a position in the first segment at which the data has a Bayes factor greater than a threshold; the determined position is designated as a second example split 122B, depicted as a dashed line at the determined position. As shown, the technique further includes splitting the first segment into two segments at the second example split 122B: a third segment comprising the portion of the example pre-processed time series 114A before the second example split 122B, and a fourth segment comprising the portion of the example pre-processed time series 114A after the second example split 122B.

Next, the technique attempts to determine positions in the example pre-processed time series 114A at which the data has a Bayes factor greater than a threshold in each of the third segment, the fourth segment, and the second segment (e.g., sequentially). However, in the example, no such positions are determined and thus no further splits are designated in the second, third, and fourth segments. Accordingly, as all splits in the example pre-processed time series 114A have been identified, the Bayesian model 122 proceeds to designate the position of the first example split 122A as a first example pre-change point 122C and the position of the second example split 122B as a second example pre-change point 122D.

In the example, the Bayesian model 122 has generated a visualization of a step function based on the example pre-processed time series 114A. The step function includes respective steps at the positions of the first example pre-change point 122C and the second example pre-change point 122D. The step function serves to provide a simplified representation of how the data is changing over time.

It will be appreciated that the example described above includes a relatively short time series with few pre-change points for ease of explanation. In practice, other (e.g., larger) numbers of splits, segments, and pre-change points may be determined by the Bayesian model 122 for a given time series.

After performing the Bayesian pre-change point detection technique to determine the pre-change points 126 in the pre-processed time series data 114, the Bayesian model 122 outputs the pre-change points 126 to the PELT model 124. As shown, the PELT model 124 also receives the pre-processed time series data 114 as an input. Optionally, the PELT model 124 can also receive a penalty value as an input. The PELT model 124 is applied to the pre-change points 126 and the pre-processed time series data 114 to determine one or more change points 128 (alternatively referred to as actual or final change points) from among the pre-change points 126. In examples where the PELT model 124 also receives a penalty value as an input, the determination of the change points 128 from among the pre-change points 126 can be based at least in part on the penalty value. The PELT model 124 can be designed to refine the detection process by optimizing the identification of the change points 128 from among the pre-change points 126. As compared to the Bayesian model 122, the PELT model 124 may be more precise and may prevent more false positives.

As shown, the PELT model 124 comprises a Radial Basis Function (RBF) model 124A. The RBF is a function in machine learning, often used in the context of Support Vector Machines (SVMs) and interpolation. In change point detection, an RBF model such as RBF model 124A can specify how the data is expected to change at each time point, helping identify the change points more effectively. Accordingly, the PELT model 124 can utilize the incorporated RBF model 124A to measure the similarity or dissimilarity between data at different positions in a time series. (e.g., by defining the expected change or similarity between the data points in different segments). In particular, applying the PELT model 124 to the pre-processed time series data 114 and the one or more pre-change points 126 can include defining expected variations between data points in different segments of the pre-processed time series data 114 using the RBF model 124A.

For illustrative purposes, an example change point 124B identified by the PELT model 124 is depicted as a dashed line at the corresponding position of the example pre-processed time series 114A. In the example, the PELT model 124 has generated a visualization of a step function which include a step at the position of the example change point 124B (e.g., to provide a simplified representation of how the data is changing over time).

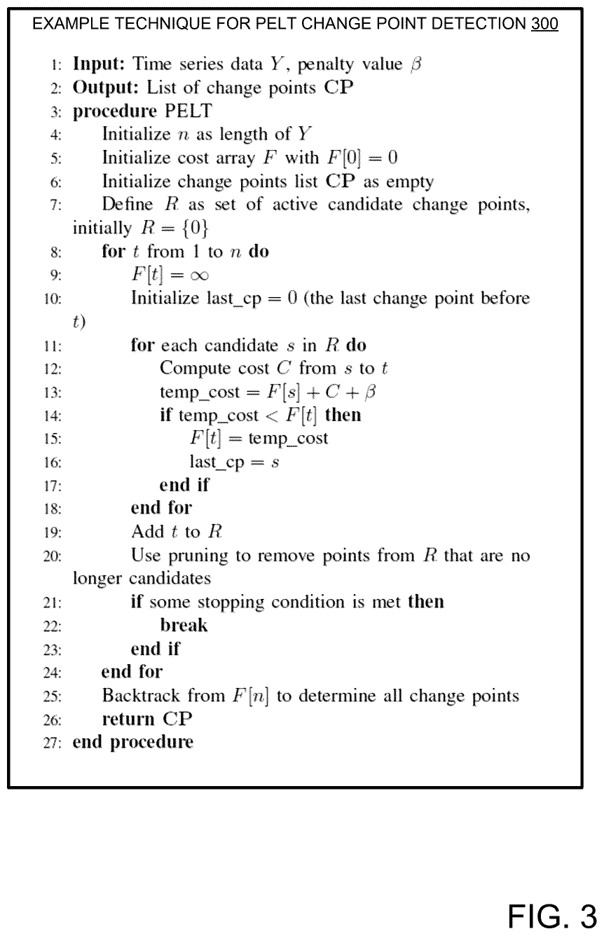

An example PELT change point detection technique 300 is described further below with reference to FIG. 3. As shown, the change points 128 determined by the PELT model are output by the combined change-point analyzer 120.

Substantial benefits are achieved by the structured and sequential application of pre-processing via the pre-processing module 110, Bayesian analysis via the Bayesian model 122, and PELT refinement by the PELT model 124. For example, after pre-processing is performed by the pre-processing module 110 to prepare the data for subsequent analysis, the Bayesian model 122 accelerates the data processing speed by swiftly pinpointing areas with potential changes. Next, the PELT model 124 builds upon this preliminary analysis by rigorously optimizing the pre-change points 126. This ultimately leads to the discernment of final, authenticated change points 128.

Each of the pre-processing module 110, the Bayesian model 122, the PELT model 124, and the combined change-point analyzer 120 can be implemented as a program module or in another manner. While the pre-processing module 110 is shown external to the combined change-point analyzer 120 in the depicted example, the pre-processing module 110 may instead be incorporated as part of the combined change-point analyzer 120.

Any of the systems herein, including the system 100, can comprise at least one hardware processor and at least one memory coupled to the at least one hardware processor.

The system 100 can also comprise one or more non-transitory computer-readable media having stored therein computer-executable instructions that, when executed by the computing system, cause the computing system to perform any of the methods described herein.

In practice, the systems shown herein, such as system 100, can vary in complexity, with additional functionality, more complex components, and the like. For example, the system 100 can include additional components to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the time series data 112, the Bayesian model 122, the PELT model 124, the RBF model 124A, the pre-change points 126, the change points 128, and the like can be stored in one or more computer-readable storage media or computer-readable storage devices. The technologies described herein can be generic to the specifics of operating systems or hardware and can be applied in any variety of environments to take advantage of the described features.

### Example 4—Example Application of Bayesian Model for Determining Pre-Change Points

When a Bayesian approach is employed for change point detection, the Bayes factor is used to quantitatively assess the evidence for competing hypotheses regarding the presence of a change point. The Bayes factor is computed by contrasting the likelihoods of the observed data under two distinct hypotheses: H₁, where the data is assumed to be homogeneous throughout (no change point), and H₂, where the data is considered to have a change point that alters the underlying data distribution parameters. This Bayesian formulation facilitates a rigorous assessment of the likelihood of change points in complex datasets, while also allowing for the incorporation of prior knowledge into the analysis.

For hypothesis H₁ (no change point), the likelihood of the data given this hypothesis, P(D|H₁), is computed as:

$$P ( D \vert {H}_{1} ) = \int p ( D \vert λ ) p ( λ \vert {H}_{1} ) d λ ) \qquad ( 1 )$$

Here, p(D|λ) represents the likelihood of the data D given the parameter λ (such as the mean of the Poisson or Gaussian distribution), and p(λ|H₁) is the prior distribution of A under the assumption of no change. For hypothesis H₂ (existence of a change point), the likelihood P(D|H₂) involves integration over parameters governing segments before (λ₁) and after (λ₂) the change point:

$$P ( D \vert {H}_{2} ) = \int \int p ( D \vert {λ}_{1} , {λ}_{2} , {t}_{s} ) p ( {λ}_{1} , {λ}_{2} \vert {H}_{2} ) d {λ}_{1} d {λ}_{2} ) \qquad ( 2 )$$

where tₛ denotes the time of the change point, p(D|λ₁, λ₂, tₛ) is the likelihood of data given the parameters before and after the change, and p(λ₁, λ₂|H₂) is the joint prior distribution of these parameters.

The Bayes factor B is then calculated by taking the ratio of these two probabilities:

$$B = \frac{P ( D \vert {H}_{2} )}{P ( D \vert {H}_{1} )} \qquad ( 3 )$$

This ratio effectively measures how much more likely the data is under the assumption of a change point than the assumption of no change. A high Bayes factor indicates strong evidence in favor of the existence of a change point.

In cases where data is assumed to follow a Poisson distribution, the Poisson distribution is often selected as it aptly describes the count of independent events occurring within a fixed time or space interval. Further, the mean of the Poisson distribution is equal to the variance of the Poisson distribution, which simplifies the data analysis process. Furthermore, the additive property of the Poisson distribution simplifies the analysis when merging multiple data sources, while its conjugate nature with Bayesian methods allows the posterior distribution to maintain an analytical form, thereby reducing computational complexity. These characteristics make the Poisson distribution theoretically appropriate and highly effective in practical applications, especially when dealing with data that exhibits count characteristics. For example, p(D|λ) for H₁ might be expressed as the product of probabilities of observing each data point under a Poisson process with a constant rate A. Similarly, for H₂, p(D|λ₁, λ₂, tₛ) would be modeled as a product of Poisson probabilities with rate λ₁ before tₛ and λ₂ after tₛ.

The integrals in the likelihood calculations generally require numerical methods, especially when the parameter space is ample or when the prior distributions are not conjugate to the likelihood functions. Methods like Markov Chain Monte Carlo approximate these integrals for computational feasibility.

To enhance Bayesian change point detection for the performance test time series data, the approach can tailored by adjusting its parameters, such as threshold and window size, to better fit the characteristics of such datasets. Table 1 below provides a summary of attributes of the tailored approach as well as modifications made to Bayesian change point detection for the tailored approach. The Bayesian technique described above with reference to FIG. 1 is an example of such a tailored approach.

TABLE 1
Summary of Attributes and Modifications

| Name | Description |
|---|---|
| Change Points Dictionary | A dictionary of pandas data frames maps each trajectory to |
| | specific attributes such as the time point split, log odds, start |
| | and end times, and the probability of change points. This |
| | structured approach allows for precisely identifying change |
| | points within the data. |
| No Split Dictionary | Another dictionary identifies time points where there is a |
| | noticeable peak in the probability of a split but which fall |
| | below a defined threshold. This feature serves to refine and |
| | validate potential change points, ensuring that only |
| | substantial changes are considered. |
| State Emission Dictionary | The state emission dictionary correlates each trajectory with |
| | the split segments' sample mean and standard deviation. |
| | This data is instrumental in generating a step function that |
| | effectively models the time series data changes. |
| Log Gamma Function | The inclusion of a log gamma function for all Ns enhances |
| | the computational efficiency of factorial-like calculations, |
| | which are often used in the statistical processes involved in |
| | the technique. |
| Threshold Adjustment | A customizable log odds threshold is set for identifying |
| | splits. Lowering this threshold causes the technique to be |
| | more sensitive to potential changes, allowing for a fine- |
| | tuned detection process tailored to the specific noise and |
| | variability characteristics of the performance data under |
| | analysis. |
| Step Function Array | A dictionary maps each trajectory to a numpy array |
| | representing the step function derived from the detected |
| | change points, thereby providing a clear visual |
| | representation of changes over time. |
| Refined Change Points | When a refinement function is applied, the refined change |
| | point dictionary is populated with newly identified splits, |
| | allowing for reevaluation and adjustment of initial findings |
| | based on more stringent criteria. |
| Window Size and Stride | The technique includes optional parameters for a moving |
| | window. By adjusting these parameters, the technique can |
| | analyze data within a flexible window frame, adapting to |
| | the dynamic nature of the performance data without a fixed |
| | window unless specified. |

FIG. 2 is a block diagram of an example Bayesian pre-change point detection technique 200 which includes the attributes and modifications set forth in Table 1 above. The technique 200 can be performed by Bayesian model 122 of FIG. 1, for example.

In the example, the technique receives time series data Y and a specified distribution type (dist) and initializes a Detector object using these inputs. An empty list (CP) is created to store detected change points, and the length of the time series data is determined.

The technique then iterates over each segment of the time series data Y. For each segment, another empty list (positions) is created to track potential change points. Next, the technique examines each position in the segment starting from the second position, calculating the log odds using a Bayes factor determination method set forth in the Detector object. The log odds refers to the natural logarithm of the odds of an event occurring. In this context, it quantifies the likelihood of a change occurring at a specific position within the time series. If the log odds exceed a predefined log odds threshold, that position is marked as a potential change point and added to the positions list. The log odds threshold can be a set value that the calculated log odds must exceed for a position to be considered a potential change point. Selecting an appropriate threshold can facilitate accurate detection of change points without introducing false positives.

If any change points are identified within a segment, they are appended to the CP list. After processing all segments, the Detector object updates its internal representation with a step function based on the detected change points. Finally, the technique returns the list CP, which contains all identified change points.

In the example, the respective Bayes factors for the positions in a given segment are determined in a sequential manner (e.g., one after the other). Similarly, the segments are processed in a sequential manner. In other examples, however, the processing of the positions in a given segment and/or the processing of the segments themselves may be performed in a different manner (e.g., in parallel).

While change points are sometimes referred to in this section for ease of explanation, the change points determined by the Bayesian model of the combined change-point analyzer are otherwise referred to as pre-change points herein (e.g., because they serve as inputs the PELT model which determines the final change points). For example, the change points in the list CP may correspond to the pre-change points 126 output by the Bayesian model 122 of FIG. 1.

### Example 5—Example Application of PELT Model for Change Point Detection

The PELT model can be applied to time series data and one or more pre-change points determined by a Bayesian model based on the time series data in order to optimize detection of change points among the one or more pre-change points. Applying the PELT model to the time series data and the one or more pre-change points can include determining respective costs of the one or more pre-change points using a penalized cost function and minimizing the penalized cost function over the time series data. Minimizing the cost function while applying a penalty for the number of change points can help to avoid overfitting.

The PELT technique aims to minimize a cost function C over the data D, segmented into n segments, subject to a penalty β for each additional change point added:

$$C ( D , n ) + β \times n \qquad ( 4 )$$

Here, C(D, n) represents the cost of segmenting the data D into n segments, and β is the penalty term that controls the trade-off between the fit of the model and the number of change points. Optimization can be performed on the value of the penalty parameter β to balance model fit and change points, thereby enhancing the accuracy and efficiency of large dataset analysis.

The PELT technique can employ an RBF of an RBF model (e.g., RBF model 124A of FIG. 1) to detect change points among one or more pre-change points. Towards this end, the RBF model can impact how C(D, n) is calculated by defining the expected change or similarity between the data points in different segments. Accordingly, applying the PELT model to time series data and one or more pre-change points can include defining expected variations between data points in different segments of the time series data using the RBF model. In such examples, the determination of the respective costs described above can be based at least in part on the expected variations defined using the RBF model.

FIG. 3 is a block diagram of an example PELT change point detection technique 300. The technique 300 can be performed by PELT model 124 of FIG. 1, for example. In the example, the technique 300 begins by taking the time series data Y and a penalty value β as inputs. The technique 300 then initializes several variables: the length n of the time series, a cost array F with its first element set to zero, and an empty list (CP) to store identified change points. At this stage, a set R is also defined to keep track of active candidate change points, with an initial value of zero.

The technique 300 then iterates over each time point t from 1 to n. For each time point, the initial cost F[t] is set to infinity and a variable representing the last change point (last_cp) is initialized to zero, representing the last change point before t. Within this loop, the technique 300 evaluates each candidate change point s in the set R by computing the cost from s to t and calculating a temporary cost (temp_cost) by adding the computed cost to the penalty value β and F[s]. If this temporary cost is less than the current cost at F[t], the technique 300 updates F[t] with the temporary cost and sets s as the last change point. The candidate change points in the set R can correspond to the pre-change points in the list CP output by the Bayesian change point detection technique 200 of FIG. 2 and the pre-change points 126 output by the Bayesian model 122 of FIG. 1, for example.

After evaluating all candidate change points, the technique 300 adds t to the set of candidate change points R and prunes candidate change points from R that are no longer viable candidates. If a stopping condition is met during this process, the technique 300 exits the loop. After exiting the loop, the technique 300 backtracks from the last element in the cost array (F[n]) to determine all change points, and returns the list CP which includes the determined change points. The change points in the list CP output by technique 300 can correspond to the change points 128 output by the PELT model 124 of FIG. 1.

### Example 6—Example Parameter Adjustment and Evaluation

Table 2 below lists example parameters used by the change point detection techniques described herein (e.g., parameters used by the combined change-point analyzer 120 of FIG. 1).

TABLE 2
Example Parameters

| Name | Description |
|---|---|
| pen | The penalty value for the PELT model, which influences the |
| | sensitivity of the PELT model to detecting change points by |
| | controlling the trade-off between detecting true changes and |
| | avoiding false positives. |
| window_size | The number of data points in each sliding window for analysis, |
| | determining the granularity of change point detection and |
| | influencing how short-term versus long-term changes in the time |
| | series are captured. |
| chunk_size | The number of data points in each chunk for processing time series |
| | data, affecting the scope of data processed at a time and influencing |
| | the computational efficiency and resolution of the change point |
| | detection. |
| log_odds_threshold | The log threshold for Bayesian detection, controlling the decision |
| | boundary for detecting a change point based on the likelihood ratio, |
| | thereby influencing the balance between sensitivity and specificity in |
| | the detection process. |

To optimize performance, a systematic tuning process can be performed using hyperparameter optimization techniques. For example, libraries for hyperparameter optimization such as Hyperopt can be used to explore the parameter space and identify the best configurations for the combined change-point analyzer. The optimization process can aim to maximize the precision and F1 score of the detection results, ensuring that the parameters are tuned to achieve a balance between detecting true positives and minimizing false positives.

Change point detection methods often involve tuning several parameters. Table 3 below lists examples of parameters of change point detection methods that may be tuned.

TABLE 3
Example Parameters for Tuning

| Name | Description |
|---|---|
| algorithm kernel | Defines the type of kernel function used, influencing how changes in |
| | the data are modeled and detected. |
| alpha | The significance level used in statistical tests, affecting the |
| | sensitivity of detection. |
| cost | A penalty term that influences the cost function, balancing sensitivity |
| | to small changes and the risk of overfitting. |
| minsize | The minimum segment size considered, preventing the detection of |
| | trivial changes. |
| threshold | A cutoff value for detecting changes, with higher thresholds leading |
| | to fewer detections. |
| intensity | Adjusts the weight given to certain features or data points, affecting |
| | the sensitivity of the method. |

The parameters set forth in Table 3 above can be optimized using a library such as Hyperopt, with the goal of maximizing precision and F1 score. This approach ensures that each method is tested under its optimal conditions, providing a robust baseline for evaluating performance.

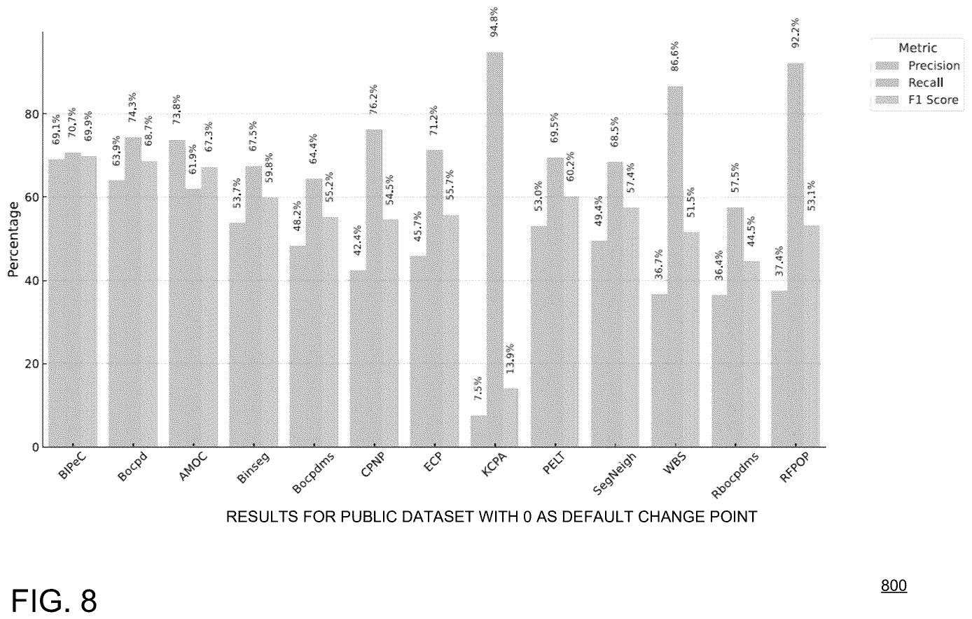

As described further below with reference to FIGS. 8-12, the effectiveness of the parameter adjustments was evaluated through a series of experiments on a dataset from performance tests performed on a large-scale database system as well as a dataset including data from publicly available sources. Precision and F1 scores were used as the primary metrics for optimization, as these metrics provide a balanced view of detection performance by considering both true positives and false positives. The parameters optimized via Hyperopt allowed the BIPEC method to achieve a balance between detection accuracy and computational efficiency. Parameter optimization was conducted for both the BIPEC method and traditional methods on the public dataset and the dataset from the large-scale database system to ensure the comparison was as fair as possible.

### Example 7—Example Method for Change Point Detection

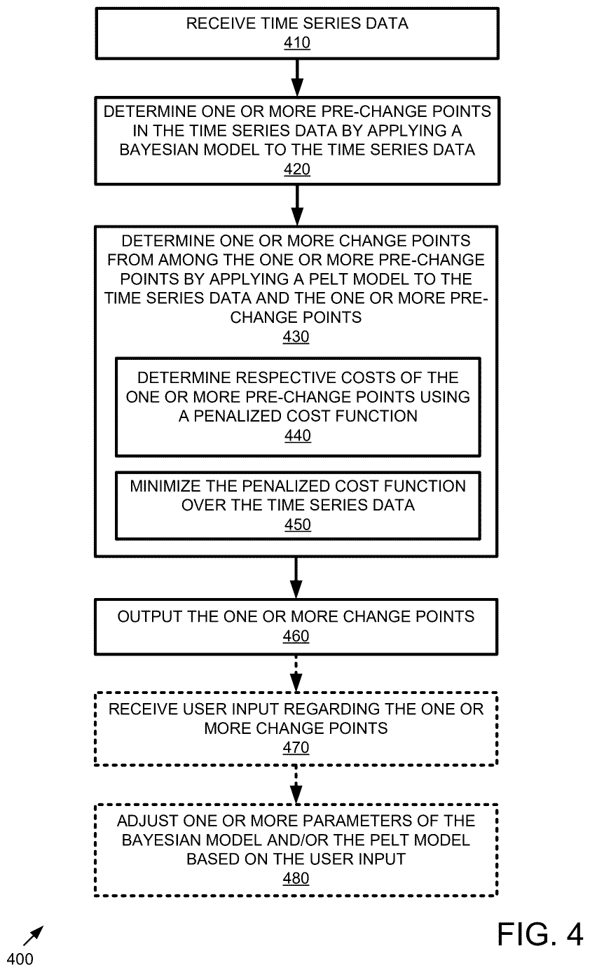

FIG. 4 is a flowchart of an example method 400 for change point detection and can be performed, for example, by the system of FIG. 1. For example, the method 400 can be a BIPEC method performed by the combined change-point analyzer 120 in conjunction with other components of system 100 of FIG. 1.

In the example, at 410, time series data is received. The time series data can include sequential data points recorded over time, representing various metrics or measurements.

At 420, one or more pre-change points in the time series data are determined by applying a Bayesian model to the time series data. For example, this can include applying Bayesian inference to identify potential change points where the statistical properties of the time series may shift.

At 430, after identifying the one or more pre-change points, the method proceeds to determine one or more change points (e.g., final change points) from among the one or more pre-change points by applying a PELT model to the time series data and the one or more pre-change points. This step refines the pre-change points to determine one or more final change points. In some examples, the PELT model can incorporate an RBF model which defines expected variations between data points in different segments of the time series.

The determination of the one or more change points includes, at 440, determining respective costs for the one or more pre-change points using a penalized cost function. The penalized cost function can evaluate the trade-off between the number of detected change points and the fit of the model to the time series data.

The determination of the one or more change points further includes, at 450, minimizing the penalized cost function over the time series data (e.g., to ensure that only significant change points are retained while avoiding overfitting by penalizing unnecessary change points).

At 460, method 400 includes outputting the one or more change points. For example, the one or more change points can be output to a client application of a database system, to a server-side component of a database system, or to another entity.

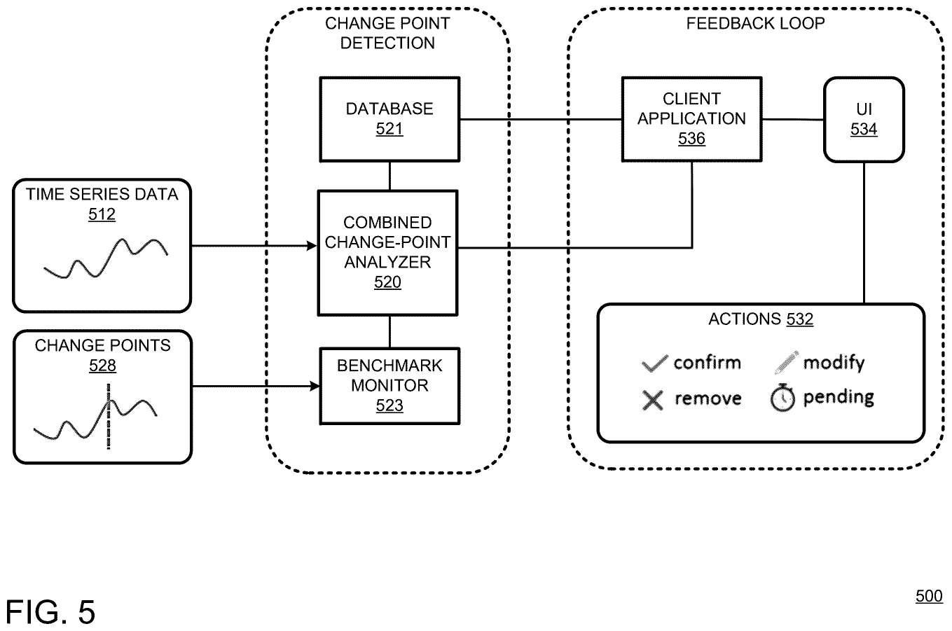

Optionally, at 470, method 400 includes receiving user input regarding the one or more change points (e.g., via a user interface). At 480, method 400 optionally includes adjusting one or more parameters of the Bayesian model and/or the PELT model based on the user input. These optional steps may be performed in a feedback loop system incorporating the combined change-point analyzer, such as the feedback loop system described below with reference to FIG. 5.

The method 400 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving time series data can be described as sending time series data depending on perspective.

### Example 8—Example Feedback Loop System for Change Point Detection

Integration of manual verification with the change point detection techniques described herein can enhance accuracy and efficiency in time series analysis. In some examples, a feedback loop system can be employed to improve the quality and reliability of change point detection (e.g., regression detection) by effectively integrating automated processes with user expertise.

FIG. 5 is a block diagram illustrating a feedback loop system 500 for change point detection which incorporates manual verification of results generated by a combined change-point analyzer. The components shown in FIG. 5 are numbered consistently with FIG. 1, except where new or modified elements are introduced; the description of like-numbered elements for FIG. 1 can also be applied to FIG. 5.

In the example, time series data 512 is input to a combined change-point analyzer 520 (e.g., combined change-point analyzer 120 of FIG. 1). The combined change-point analyzer 520 automatically scans the time series data 512 to identify change points 528 via the combined change-point techniques described herein. The change points 528 can represent substantial alterations in data trends, such as shifts in mean, variance, or other statistical properties. The change points 528 determined by the combined change-point analyzer 520 can be stored in a database 521. In addition to the change points 528, the database 521 can also store other data related to performance testing.

In the example, the feedback loop system 500 also includes a benchmark monitor 523. The benchmark monitor 523 can include a performance measurement framework and a web-based reporting application, e.g., for performance regression tests. The benchmark monitor 523 can help analyze the performance development of the database and support functionality such as continuous integration. Towards this end, the benchmark monitor 523 can capture metrics such as elapsed time, CPU time, and memory consumption, and store the metrics in a database (e.g., database 521). As shown, the benchmark monitor 523 can receive the change points 528 as inputs, among other data.

After being detected and stored, the change points 528 undergo manual scrutiny. For example, users can engage in a review process in which they can perform actions 532 such as interaction with and annotation of the change points 528 via a user interface (UI) 534 of a client application 536. For example, while users cannot alter the sequence or position of the time series data, users can add or modify additional information such as annotations, labels, or classifications at specific points within the time series.

The actions 532 serve to generate user input regarding the change points 528. The user input can be recorded in a database (e.g., database 521) and serve as part of the feedback loop to further optimize the change-point detection process. Client application 536 can be a client application of a database system which incorporates the combined change-point analyzer 520 and the database 521, among other components.

As shown, the actions 532 can include confirming whether a given change point of the change points 528 accurately represents a notable data event, in which case the given change point is designated as confirmed. In cases where a given change point is deemed irrelevant or false by a user, the given change point can be removed from consideration. For ambiguous cases, where a clear decision by a user for a given change point is not immediate, the actions 532 can include the user tagging the given change point as a pending change point for further review. If a given change point is valid but inaccurately positioned, the actions 532 can include a user manually adjusting the position of the given change point and designating the given change point as a modified change point.

Accordingly, the user input generated for a given change point of the change points 528 via the manual verification process can include, for example, an indication to designate the given change point as a confirmed change point, an indication to remove the given change point, an indication to designate the given change point as a pending change point for further review, or an indication to adjust a position of the given change point and designate the given change point as a modified change point.

It will be appreciate that description pertaining to a given change point of the change points 528 can pertain to all of the change points 528 or some subset of the change points 528 (e.g., fewer than all of the change points 528). For example, user input may be received for all change points 528 in some cases, such that every one of the change points 528 is either removed or designated as confirmed, modified, or pending. Alternatively, in some cases, user input may only be received for some of the change points 528, such that only some of the change points are removed or provided with corresponding designations based on the user input.

Post-verification, all results, encompassing confirmed, removed, pending, and modified change points, can be stored in the database 521. This centralized storage can ensure data integrity and facilitate subsequent analysis. The manually verified results stored in database 521 can be leveraged for model parameter optimization during periodic updates to the model parameters. This iterative refinement process can utilize the real-world user feedback obtained via the feedback loop system 500 to enhance the ability of the model to identify and position change points in future datasets more precisely. For example, the user input stored in the database 521 can be retrieved in response to initiation of an update to one or more of the models utilized by the combined change-point analyzer 520 (e.g., an update to the Bayesian model, the PELT model, and/or the RBF model), during such an update, or at another appropriate time.

During the update of a given model, one or more parameters of the model can be adjusted based on the user input. For example, for the PELT model, the penalty value parameter controls the trade-off between the number of detected change points and the fit of the model. If the PELT model is detecting too many false positives, the penalty value can be increased to reduce the number of detected change points (e.g., to align the output of the PELT model more closely with manually verified results).

Accordingly, in a data collection phase, manually verified change points are systematically recorded in the database, providing a reliable dataset for model evaluation. In a model evaluation phase, the performance of each model (i.e., the Bayesian model, the PELT model, and RBF model) is assessed by comparing its detected change points against the manually verified ones, calculating metrics such as precision, recall, and F1 score. In a parameter adjustment phase, based on the evaluation, hyperparameters of each model are fine-tuned to improve alignment with the verified change points. For instance, in the Bayesian model, parameters like prior distributions are adjusted; in the PELT model, penalty values are modified; and in the RBF model, kernel parameters are optimized. This process is repeated periodically to iteratively refine the models by incorporating new manual verifications to continually enhance the accuracy of the models in detecting change points.

Accordingly, the feedback loop system 500 can foster a continuous feedback loop in which user interactions and decisions feed directly into the system, driving ongoing enhancements in change point detection algorithms and overall system performance. The feedback loop system 500 enhances the precision of change point detection, making it essential for practical applications such as regression detection. By integrating automated detection with manual verification, the feedback loop system 500 can accurately identify performance regressions even in large-scale database systems.

Further, the manual verification step included in the feedback loop system 500 can eliminate irrelevant change points, thereby reducing false positives and enhancing reliability. The iterative feedback loop continuously fine-tunes model parameters, improving detection accuracy. This approach has been validated through testing on both a public dataset and a dataset from an existing productive large-scale database system, demonstrating its effectiveness in complex, large-scale data environments.

### Example 9—Example Implementations

Any of the following can be implemented.

Clause 1. A computer-implemented method comprising: receiving time series data; determining one or more pre-change points in the time series data by applying a Bayesian model to the time series data; determining one or more change points from among the one or more pre-change points by applying a Pruned Exact Linear Time (PELT) model to the time series data and the one or more pre-change points, wherein applying the PELT model to the time series data and the one or more pre-change points comprises: determining respective costs of the one or more pre-change points using a penalized cost function; and minimizing the penalized cost function over the time series data; and outputting the one or more change points.

Clause 2. The method of Clause 1, wherein applying the Bayesian model to the time series data comprises determining respective Bayes factors for positions in the time series data.

Clause 3. The method of Clause 2, wherein positions of the one or more pre-change points are specified in a list, and wherein applying the Bayesian model to the time series data further comprises: comparing the respective Bayes factors for the positions to a predefined threshold; identifying a subset of the positions based on the comparison, wherein the positions in the subset have respective Bayes factors that exceed the predefined threshold; designating the positions in the subset as pre-change points; and adding the positions in the subset to the list.

Clause 4. The method of Clause 3, wherein the predefined threshold is a customizable log odds threshold.

Clause 5. The method of any one of Clauses 1-4, wherein: the PELT model incorporates a Radial Basis Function (RBF) model; applying the PELT model to the time series data and the one or more pre-change points further comprises defining expected variations between data points in different segments of the time series data using the RBF model; and the determination of the respective costs is based at least in part on the expected variations.

Clause 6. The method of any one of Clauses 1-5, further comprising receiving a distribution type of the time series data, wherein the determination of the one or more pre-change points is based at least in part on the distribution type.

Clause 7. The method of any one of Clauses 1-6, further comprising receiving a penalty value, wherein the determination of the one or more change points from among the one or more pre-change points is based at least in part on the penalty value.

Clause 8. The method of any one of Clauses 1-7, wherein the time series data comprises pre-processed time series data which has undergone pre-processing to reduce noise in the time series data and remove outliers from the time series data.

Clause 9. The method of any one of Clauses 1-8, further comprising receiving user input regarding the one or more change points; and adjusting one or more parameters of the Bayesian model and/or the PELT model based on the user input.

Clause 10. The method of Clause 9, wherein the user input comprises at least one of the following for a given change point of the one or more change points: an indication to designate the given change point as a confirmed change point; an indication to remove the given change point; an indication to designate the given change point as a pending change point for further review; or an indication to adjust a position of the given change point and designate the given change point as a modified change point.

Clause 11. The method of Clause 10, further comprising: storing the user input in a database; and retrieving the user input in response to at least one of the following: initiation of an update to the Bayesian model; or initiation of an update to the PELT model.

Clause 12. A computing system, comprising: at least one hardware processor; at least one memory coupled to the at least one hardware processor; a stored Bayesian model and a stored Pruned Exact Linear Time (PELT) model that incorporates a Radial Basis Function (RBF) model; and one or more non-transitory computer-readable media having stored therein computer-executable instructions that, when executed by the computing system, cause the computing system to perform operations implementing a combined change-point analyzer, the operations comprising: receiving time series data; determining one or more pre-change points in the time series data by applying the Bayesian model to the time series data; determining one or more change points from among the one or more pre-change points by applying the PELT model to the time series data and the one or more pre-change points; and outputting the one or more change points.

Clause 13. The system of Clause 12, further comprising a pre-processing module comprising computer-executable instructions that, when executed by the computing system, cause the computing system to perform operations comprising: receiving raw time series data; pre-processing the raw time series data, wherein the pre-processing of the raw time series data comprises reducing noise in the raw time series data and removing one or more outlier data points from the raw time series data; and outputting the pre-processed raw time series data to the combined change-point analyzer as the time series data.

Clause 14. The system of Clause 12 or Clause 13, wherein the operations further comprise: receiving user input regarding the one or more change points; and adjusting one or more parameters of the Bayesian model, the PELT model, and/or the RBF model based on the user input.

Clause 15. The system of Clause 14, wherein the user input comprises at least one of the following for a given change point of the one or more change points: an indication to designate the given change point as a confirmed change point; an indication to remove the given change point; an indication to designate the given change point as a pending change point for further review; or an indication to adjust a position of the given change point and designate the given change point as a modified change point.

Clause 16. The system of Clause 14 or Clause 15 further comprising a database, wherein the operations further comprise: storing the user input in the database; and retrieving the user input in response to at least one of the following: initiation of an update to the Bayesian model; initiation of an update to the PELT model; or initiation of an update to the RBF model.

Clause 17. One or more non-transitory computer-readable media comprising computer-executable instructions that, when executed by a computing system, cause the computing system to perform operations comprising: receiving time series data; determining one or more pre-change points in the time series data by applying a Bayesian model to the time series data; determining one or more change points from among the one or more pre-change points by applying a Pruned Exact Linear Time (PELT) model to the time series data and the one or more pre-change points, wherein applying the PELT model to the time series data and the one or more change points comprises: determining respective costs of the one or more pre-change points using a penalized cost function; and minimizing the penalized cost function over the time series data; outputting the one or more change points; receiving user input regarding the one or more change points; and adjusting one or more parameters of the Bayesian model and/or the PELT model based on the user input.

Clause 18. The computer-readable media of Clause 17, wherein the user input comprises one of the following for a given change point of the one or more change points: an indication to designate the given change point as a confirmed change point; an indication to remove the given change point; an indication to designate the given change point as a pending change point for further review; or an indication to adjust a position of the given change point and designate the given change point as a modified change point.

Clause 19. The computer-readable media of Clause 17 or Clause 18, wherein the operations further comprise: storing the user input in a database; and retrieving the user input in response to at least one of the following: initiation of an update to the Bayesian model; or initiation of an update to the PELT model.

Clause 20. The computer-readable media of any one of Clauses 17-19, wherein the PELT model incorporates a Radial Basis Function (RBF) model, and wherein the operations further comprise: adjusting one or more parameters of the RBF model based on the user input.

### Example 10—Example Advantages

A number of advantages can be achieved via the technologies described herein. In general, the disclosed technologies offer a more precise, efficient, and scalable approach to performance regression detection compared to existing methods.

For example, initiating the change point detection process with Bayesian methods can advantageously address uncertainty and capture global data characteristics without the need for excessive assumptions about model parameters. Subsequently, passing the change point detection results to the PELT technique with RBF modeling allows for a more precise refinement and confirmation of the change point locations.

Further, whereas traditional methods typically use a single approach for identifying performance regressions, the disclosed combined change-point analyzer uniquely combines Bayesian inference with the PELT method for more accurate change-point and performance regression detection. The Bayesian and the PELT approaches have distinct change point detection strategies and strengths and weaknesses; the Bayesian approach may be more sensitive to detecting potential change points but might lead to false positives, whereas the PELT approach, with known models, may offer higher precision. Combining the Bayesian and PELT approaches can allow each approach to complement the weakness of the other approach.

As another example, in contrast to manual techniques for identifying performance regressions, the disclosed technologies are automated which saves time and resources by significantly reducing the need for human intervention.

Such technologies can also improve accuracy compared to traditional methods. As a result, the disclosed technologies achieve higher precision and generate fewer false positives. By identifying potential change points using Bayesian methods and then employing the PELT technique with RBF modeling for fine-tuning, the false positive rate can be lowered to provide more trustworthy results. For example, the combined change-point analyzer achieved an F1 score of 93% and a precision of 92% during trials on a dataset including performance test results from a large-scale database system, thus demonstrating excellent detection capabilities in a large-scale environment.

In addition, if the data contains noise or random fluctuations, the PELT technique alone may be sensitive to these fluctuations and detect false positives. Bayesian methods often introduce appropriate prior distributions to mitigate sensitivity to noise, reducing the occurrence of false positives. The characteristics of the data distribution can also influence performance. If the data distribution is regular, the PELT technique may lead to false positives, whereas Bayesian methods tend to adapt better to different data distributions. Accordingly, by integrating Bayesian and PELT techniques in a combined change-point analyzer, the disclosed technologies can avoid issues that occur when PELT techniques are used on their own.

As another example, the computational complexity of the PELT technique can be linear under certain conditions. For example, when the number of change points increases linearly with the number of observations, the PELT technique can achieve linear time complexity. Further, the pruning step included in the PELT technique can reduce the number of calculations needed by eliminating potential change points which are unlikely to be included in the solution. Accordingly, the PELT technique can be particularly efficient when applied to large datasets which include a large number of change points. As compared to exhaustive search methods, the PELT technique can significantly reduce computational overhead, making it more practical for large datasets.

As yet another example, the disclosed technologies can simplify user interaction during performance regression identification by minimizing manual tasks. This in turn can provide enhanced usability.

Further, the disclosed technologies can incorporate a feedback loop that continuously refines detection accuracy. In contrast, existing methods for performance regression detection lack such functionality.

Furthermore, the disclosed technologies can efficiently handle large datasets and real-time analysis, thereby addressing the limitations of prior methods in large-scale environments.

### Example 11—Example Synergy Achieved By Combined Change-Point Analyzer

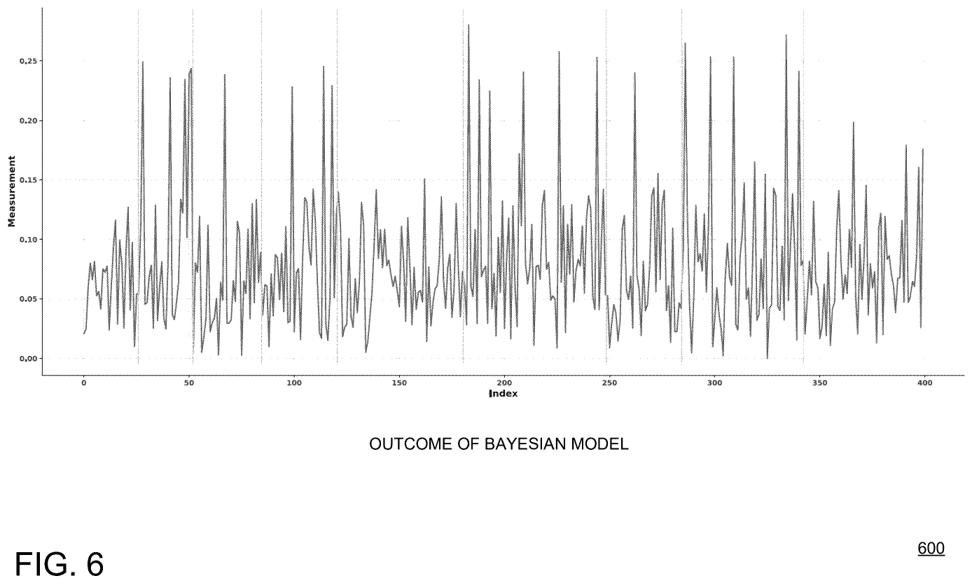

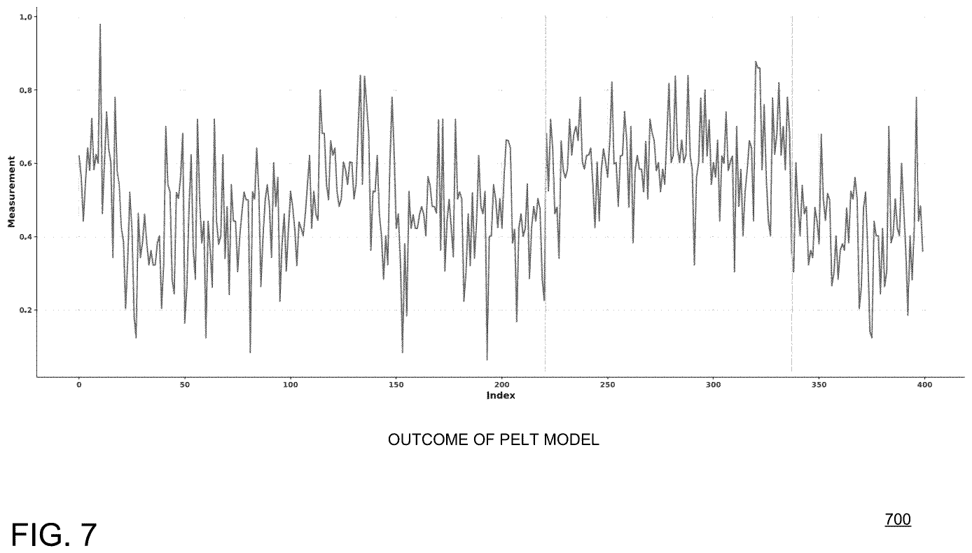

The disclosed techniques integrate the strengths of Bayesian and PELT methodologies to achieve a synergistic solution which overcomes the individual shortcomings of these methodologies. To better illustrate this point, FIGS. 6 and 7 depict graphs of the outcomes of the Bayesian and PELT techniques, respectively.

In particular, FIG. 6 depicts a graph 600 showing change points detected via the Bayesian approach (e.g., by applying a Bayesian model). The results shown in graph 600 illustrate the high sensitivity of the Bayesian approach, which, when applied to fluctuating time series, tends to identify multiple change points. This level of sensitivity often leads to the detection of more change points than anticipated, which, while not always aligning with expectations, is a deliberate design choice to ensure rigorous analysis. Such stringency prevents the oversight of genuine change points, thereby maintaining the integrity of the change point detection process.

FIG. 7 depicts a graph 700 showing change points detected via the PELT approach (e.g., by applying a PELT model). The results shown in graph 700 demonstrate that the PELT approach exhibits heightened sensitivity to regular time series, often identifying numerous change points. However, the Bayesian method processes such data more precisely, effectively discerning the valid change points.

Consequently, a combined approach is necessary to integrate the strengths of both Bayesian and PELT methodologies. This synergy aims to mitigate the detection of spurious change points while ensuring no genuine ones are overlooked, thus achieving a balanced and accurate analysis.

### Example 12—Example Experiment Design and Dataset

During conception of the disclosed techniques, the inventors experimented with various other combinations of change point detection methods such as BOCPD and PELT. However, when compared to the combined change-point analyzer described herein, these combinations fell short in performance and scalability, particularly in large-scale scenarios where the computational complexity of BOCPD was less efficient. In contrast, the combined change-point analyzer effectively integrates Bayesian methods with PELT, thereby balancing real-time detection with efficiency. As a results, the combined change-point analyzer is suitable for large-scale data environments.

The inventors evaluated the combined change-point analyzer using two distinct datasets: one with thousands of performance tests from instances of a large-scale database system, and another from publicly available data. Both datasets underwent rigorous pre-processing to normalize metrics and ensure consistency. The evaluation focused on detection accuracy, computational efficiency, and scalability. This comprehensive approach validated the combined change-point analyzer methodology in the context of the complex performance tests used in the large-scale database system and confirmed the robustness of the methodology across broader, public datasets. This dual-dataset strategy provided a thorough assessment of the performance of the combined change-point analyzer across varied data landscapes.

The public time series data for this study were sourced from a variety of online platforms, including World Bank, Eurostat, U.S. Census Bureau, GapMinder, and Wikipedia. Some of these series exhibited potential change points during global events like the 2007-2008 financial crisis, influencing variables such as Brent crude oil prices, U.S. business inventories, and GDP in several countries. Other series were linked to legislative actions, such as the UK's seat belt regulations and the Montreal Protocol's restrictions on CFC emissions. Additionally, datasets from previous studies on change point detection were included, such as the well-log, Nile River, and bee-waggle datasets. These datasets were selected based on their display of notable patterns, including sudden changes, seasonal effects, or the presence of outliers. In total, 37 real-time series were assembled, consisting of 33 univariate and 4 multivariate series. Among these, one univariate series contained missing values, and several others exhibited seasonal trends. To further diversify the dataset, five synthetic “quality control” series with predetermined change points were discreetly added, bringing the total to 42 time series. The series varied in length, with an average of 328 data points, ranging from 15 to 991 points.

The performance test dataset from the large-scale database system was specifically designed to capture a wide range of performance metrics that provide insight into system behavior under various conditions. These metrics included detailed measurements related to individual bugs and their direct impact on system performance, as well as metrics focused on specific types of queries and query patterns. Additionally, the dataset included data associated with particular combinations of queries and system states, offering a comprehensive view of performance under diverse scenarios. In total, 1,314 unidimensional time series were sourced; these time series varied in length, with the shortest being 269 points and the longest reaching 654 points. Further, 76.33% of the selected time series had a length of exactly 400 points. All data originate from a database of performance test results for an existing large-scale database system, ensuring relevance to practical applications. To guarantee the accuracy of the annotations, three different annotators were employed for the labeling process. On average, the time series length in this dataset is approximately 420 points.

To assess the efficacy of the combined change-point analyzer, statistical tests were employed on datasets with preestablished change points, treating the evaluation process akin to a task in machine learning. An objective of the combined change-point analyzer is to pinpoint change points within an input dataset with high precision, mirroring the process of deducing known outcomes from a set of training data. In this evaluation framework, the F1 score was leveraged as a holistic measure of accuracy, combining the insights of both precision and recall into a single metric. Precision was also emphasized in order to directly gauge the ability of the combined change-point analyzer to identify true positives accurately without excess false positives. This dual metric approach, incorporating both F1 score and precision, ensured a balanced evaluation of the performance of the combined change-point analyzer. Through this refined assessment strategy, the capability of the combined change-point analyzer to accurately detect change points was comprehensively evaluated, thus affirming the utility and effectiveness of this technique within complex data environments.

In the context of the performance tests performed for the combined change-point analyzer, true positives can be defined using two sets:
X*: the set of ground truth change points; and
X: the set of predicted change points.
   True positives refer to the set of detected change points that correctly correspond to actual change points in the data. In other words, these are the change points that are both predicted by the model and present in the true set of change points. The accuracy of these predictions is assessed within a defined margin of error, denoted as M. Specifically, if the difference between a predicted change point and the corresponding true change point is less than or equal to M, then the predicted change point is considered correctly identified. This approach allows for some flexibility in the timing of the detected change points, accounting for small deviations. Mathematically, TP(X, X*): {x∈X|∃x*∈X*s·t·|x−x*|≤M}. It is important to prevent double-counting a single X* change point as matched by multiple predictions within the margin M.

F1 score is selected for its robustness against variations in the size and density of the dataset and its capacity to penalize false positives while rewarding correct detections. It represents the harmonic mean of precision and recall, where:

$$F 1 = \frac{2 \times precision \times recall}{precision + recall} \qquad ( 5 )$$

Precision is the fraction of correctly predicted positive observations from the total predicted positives.

$$Precision = \frac{\vert TP ( X , {X}^{*} ) \vert}{\vert X \vert} \qquad ( 6 )$$

Recall (or sensitivity) is the fraction of correctly predicted positive observations from all actual positives.

$$Recall = \frac{\vert TP ( X , {X}^{*} ) \vert}{\vert X \vert} \qquad ( 7 )$$

FIGS. 8-12 depict comparative results of various change point detection methods, including the BIPEC method performed by the combined change-point analyzer. In particular, in addition to results for BIPEC, results are shown for the following change point detection methods: BOCPD, At Most One Change (AMOC), BINSEG, BOCPD with Model Selection (BOCPDMS), Nonparametric Change Point Detection (CPNP), Energy Change Point (ECP), Kernel Change-Point Analysis (KCPA), PELT, Segment Neighborhoods (SEGNEIGH), WBS, Robust BOCPDMS (RBOCPDMS), and Robust Functional Pruning Optimal Partitioning (RFPOP).

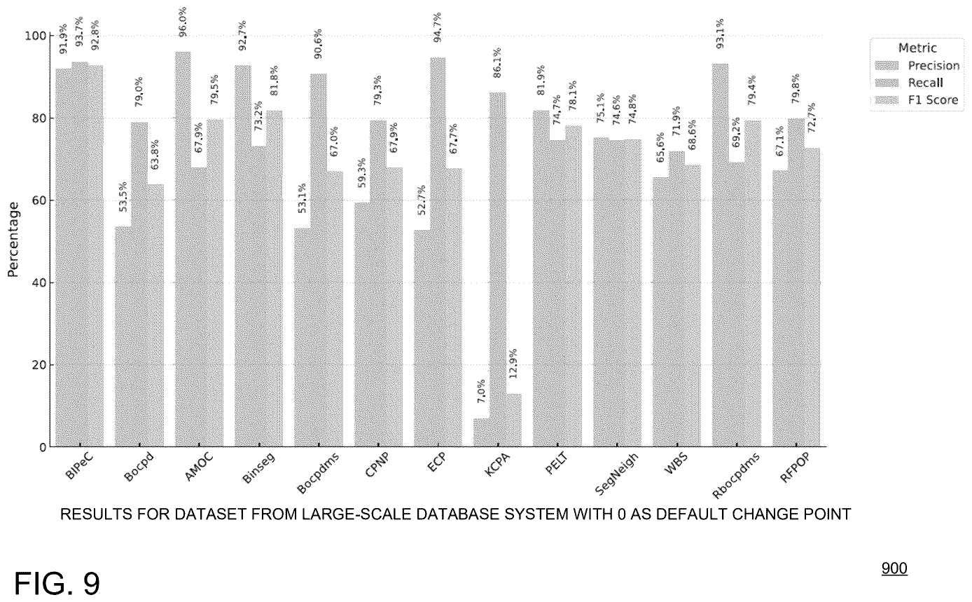

The results shown in FIGS. 8 and 9 were obtained under the specific condition that zero is treated as the default change point. In particular, FIG. 8 depicts a graph 800 of results obtained for the public dataset with zero as the default change point, and FIG. 9 depicts a graph 900 of results obtained for the dataset from the large-scale database system with zero as the default change point. This means that both predictions and annotations within the datasets inherently recognize zero as a change point. In change point detection for time series data, treating the initial point (t=0) as a default change point is a common practice. This approach helps in algorithmic initialization by providing a uniform reference point, ensuring consistency across different datasets and analyses. By marking t=0 as a change point, the detection of subsequent changes becomes more straightforward, as the algorithm measures shifts relative to this baseline.

Additionally, including t=0 helps manage boundary conditions, preventing distortions that might occur at the start of the series. This ensures a consistent framework for detecting and analyzing changes, making the process more reliable and reproducible. However, in cases where the initial conditions are not representative of the series' overall behavior, excluding t=0 as a change point might be more appropriate, allowing the methodology to adapt to specific analysis needs.

Even under these constraints, the BIPEC method performs excellently on both the public dataset and the dataset from the large-scale database system. As shown in graph 800, for the public dataset, the BIPEC method achieved an F1 score of about 70% and a precision of about 69%. In contrast, for the dataset from the large-scale database system, the BIPEC method achieved an F1 score of about 93% and a precision of about 92% (i.e., the top overall performance among the tested methods). Accordingly, the results indicate that that the BIPEC method is adept at identifying other valid change points in the data while correctly handling the imposed default conditions. The performance of the BIPEC method thus demonstrates its high detection accuracy and resistance to potential biases introduced by the default zero change point assumption.

It is worth noting that the effectiveness of the BIPEC method relative to other methods, such as BINSEG, PELT, and BOCPD, could partly be attributed to its architecture, which possibly incorporates sophisticated mechanisms to mitigate the influence of default change point assumptions on the overall detection process. This nuanced capability allows the BIPEC method to deliver reliable results even when the datasets are pre-conditioned with certain expectations, reinforcing the robustness and adaptability of the disclosed techniques in varied analytical contexts.

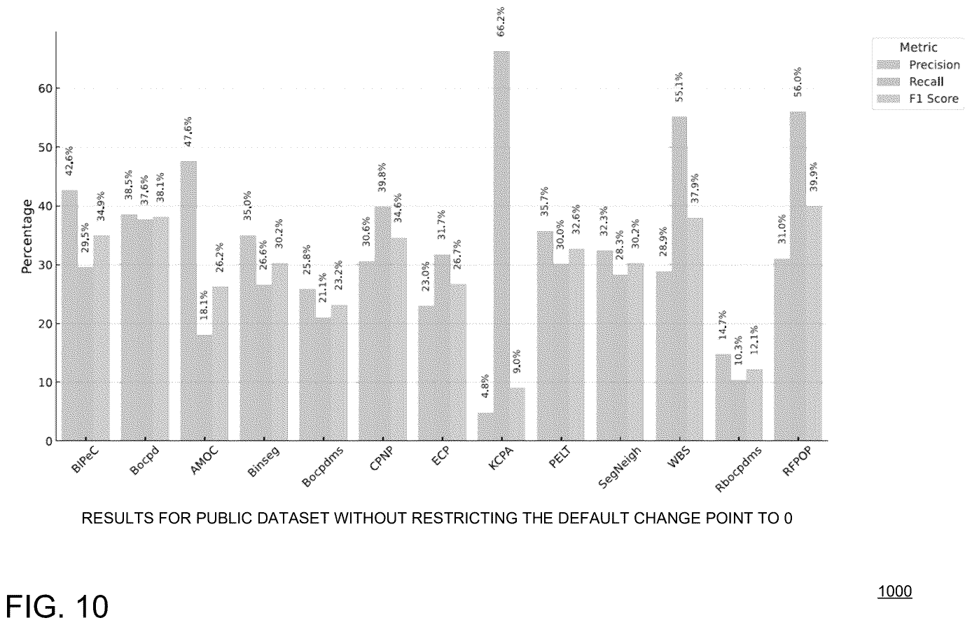

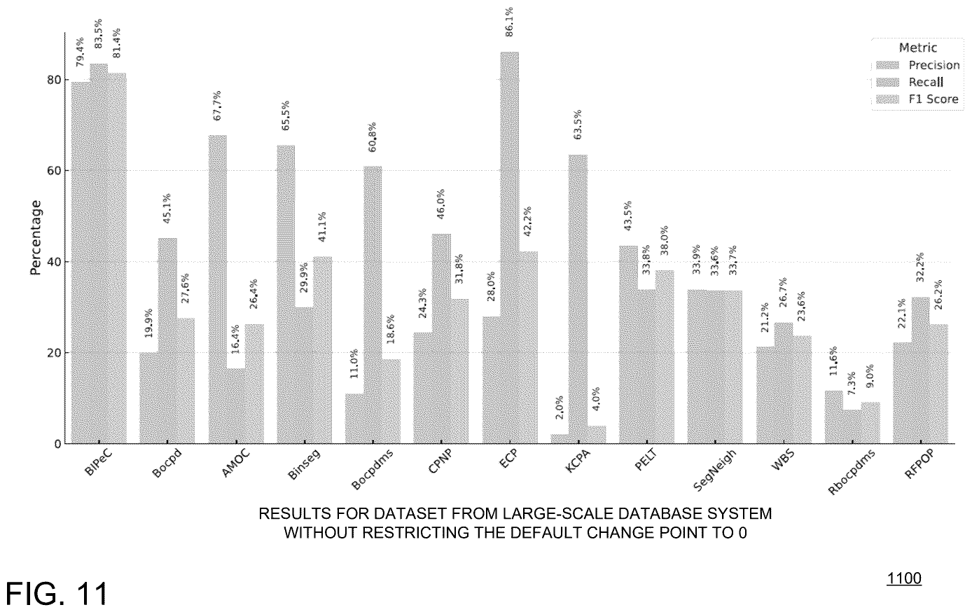

FIGS. 10 and 11 show the results achieved without restricting zero as the default change point. In particular, FIG. 10 depicts a graph 1000 of results obtained for the public dataset without restricting the default change point to zero, and FIG. 11 depicts a graph 1100 of results obtained for the dataset from the large-scale database system without restricting the default change point to zero. As shown in graph 1000, for the public dataset, the precision and F1 scores of the BIPEC method are high. As shown in graph 1100, the precision of the BIPEC method for the dataset from the large-scale database system is somewhat lower (approximately 79%), the F1 score of the BIPEC method is somewhat lower (approximately 81%), and the F1 score of the other methods is below 50%. This demonstrates that the BIPEC method outperforms the other methods in the context of a large-scale database systems. Accordingly, without assuming zero as a change point, the capacity of the BIPEC method to identify shifts within the data is revealed, underscoring its robustness and precision. This reflects the sophisticated design of the BIPEC method, which likely allows it to effectively manage and analyze the complexity inherent in performance test data, leading to high precision.

The different conditions depicted in graphs 800, 900, 1000, and 1100 present a comprehensive picture of the capabilities of the BIPEC method. Under default change point assumption conditions, BIPEC method demonstrates high precision; however, its performance is even more remarkable without this assumption. This suggests that in addition to being fine-tuned to handle the artificial boost of treating zero as a change point, the BIPEC method is genuinely adept at discerning the nuances of change point data.

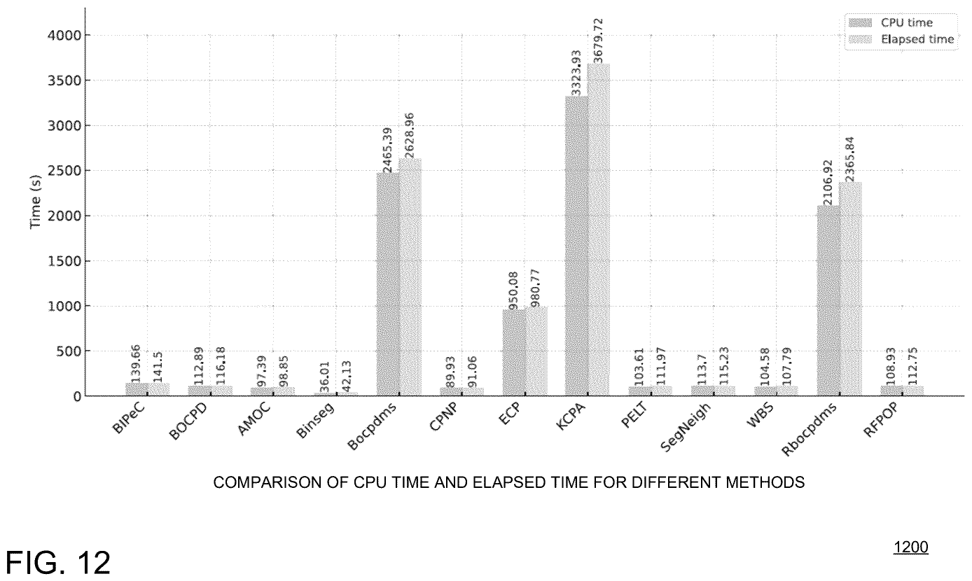

FIG. 12 depicts a graph 1200 of the CPU time and elapsed time achieved for the different methods. In particular, graph 1200 reflects the actual performance of the BIPEC method and the other methods on both datasets. When combined, these insights substantiate the superiority of the BIPEC method in change point detection, particularly within the complex data landscapes of performance testing. The adaptability of the BIPEC method to both conditions indicates its potential to provide reliable, nuanced analysis, proving an indispensable tool in performance monitoring and evaluation.

In change point detection, a larger dataset is crucial. More data points provide richer information, enabling algorithms to better identify patterns and trends, improving detection accuracy. A large dataset helps distinguish between noise and actual signals, reducing false positives and false negatives. It also enhances model stability by allowing more accurate parameter estimation. Additionally, larger datasets can reveal subtle and complex changes, making detection methods more adaptable and flexible. They also help analyze long-term trends and cyclical variations, offering valuable insights for strategic decision-making. Overall, more data improves the accuracy, reliability, and effectiveness of change point detection. Initially, the dataset from the large-scale database system only covered half a year; daily performance tests were then conducted, which resulted in many data points. This extensive data allowed for better handling of inaccuracies in the results, which led to a noticeable decrease in false positive detections of change points.

That being said, the experiments have shown that the BIPEC method remains effective even with smaller datasets. While the algorithm can operate with limited data, the effectiveness depends on the complexity and variability of the data. Having a sufficient number of data points to capture the essential dynamics can help to ensure reliable detection. Although the BIPEC method can provide reliable insights with smaller datasets, a larger dataset is preferable as it generally yields more accurate results. In addition, proper calibration and adjustment of detection parameters can maximize effectiveness, thereby enhancing operational efficiency and decision-making processes.

### Example 13—Example Computing Systems

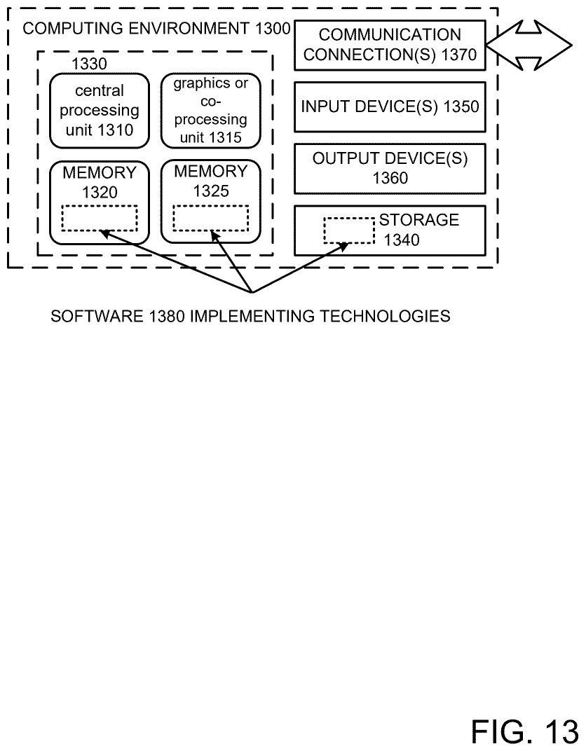

FIG. 13 depicts an example of a suitable computing system 1300 in which the described innovations can be implemented. The computing system 1300 is not intended to suggest any limitation as to scope of use or functionality of the present disclosure, as the innovations can be implemented in diverse computing systems.

With reference to FIG. 13, the computing system 1300 includes one or more processing units 1310, 1315 and memory 1320, 1325. In FIG. 13, this basic configuration 1330 is included within a dashed line. The processing units 1310, 1315 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 13 shows a central processing unit 1310 as well as a graphics processing unit or co-processing unit 1315. The tangible memory 1320, 1325 can be volatile memory (e.g., registers, cache, RAM), non-volatile memory (e.g., ROM, EEPROM, flash memory, etc.), or some combination of the two, accessible by the processing unit(s) 1310, 1315. The memory 1320, 1325 stores software 1380 implementing one or more innovations described herein, in the form of computer-executable instructions suitable for execution by the processing unit(s) 1310, 1315.

A computing system 1300 can have additional features. For example, the computing system 1300 includes storage 1340, one or more input devices 1350, one or more output devices 1360, and one or more communication connections 1370, including input devices, output devices, and communication connections for interacting with a user. An interconnection mechanism (not shown) such as a bus, controller, or network interconnects the components of the computing system 1300. Typically, operating system software (not shown) provides an operating environment for other software executing in the computing system 1300, and coordinates activities of the components of the computing system 1300.

The tangible storage 1340 can be removable or non-removable, and includes magnetic disks, magnetic tapes or cassettes, CD-ROMs, DVDs, or any other medium which can be used to store information in a non-transitory way and which can be accessed within the computing system 1300. The storage 1340 stores instructions for the software 1380 implementing one or more innovations described herein.

The input device(s) 1350 can be an input device such as a keyboard, mouse, pen, or trackball, a voice input device, a scanning device, touch device (e.g., touchpad, display, or the like) or another device that provides input to the computing system 1300. The output device(s) 1360 can be a display, printer, speaker, CD-writer, or another device that provides output from the computing system 1300.

The communication connection(s) 1370 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example 14—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example 15—Example Cloud Computing Environment

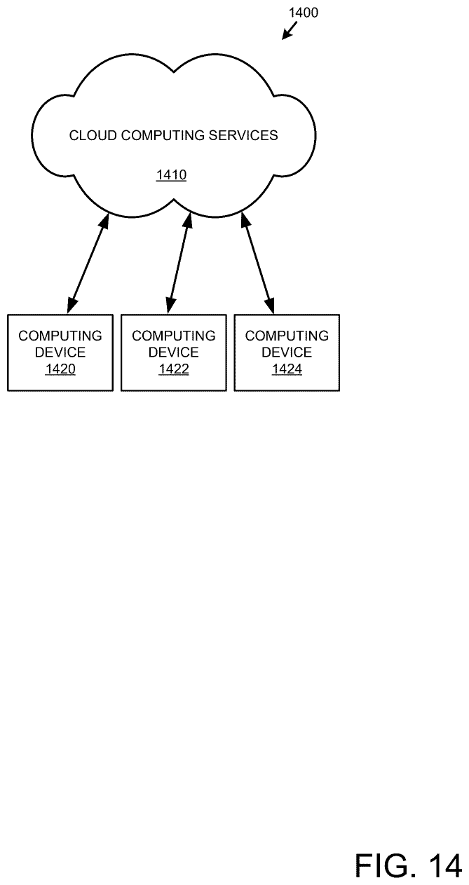

FIG. 14 depicts an example cloud computing environment 1400 in which the described technologies can be implemented, including, e.g., the system 100 of FIG. 1 and other systems herein. The cloud computing environment 1400 comprises cloud computing services 1410. The cloud computing services 1410 can comprise various types of cloud computing resources, such as computer servers, data storage repositories, networking resources, etc. The cloud computing services 1410 can be centrally located (e.g., provided by a data center of a business or organization) or distributed (e.g., provided by various computing resources located at different locations, such as different data centers and/or located in different cities or countries).

The cloud computing services 1410 are utilized by various types of computing devices (e.g., client computing devices), such as computing devices 1420, 1422, and 1424. For example, the computing devices (e.g., 1420, 1422, and 1424) can be computers (e.g., desktop or laptop computers), mobile devices (e.g., tablet computers or smart phones), or other types of computing devices. For example, the computing devices (e.g., 1420, 1422, and 1424) can utilize the cloud computing services 1410 to perform computing operations (e.g., data processing, data storage, and the like).

In practice, cloud-based, on-premises-based, or hybrid scenarios can be supported.

### Example 16—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 17—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method for detecting performance regressions in a database system, comprising:
receiving time series data representing performance test results for a database system;
determining a set of candidate change points comprising a plurality of pre-change points in the time series data by applying a Bayesian model to the time series data;
determining one or more change points from among the set of candidate change points by applying a Pruned Exact Linear Time (PELT) model to the time series data and the plurality of pre-change points, wherein applying the PELT model to the time series data and the plurality of pre-change points comprises:
determining respective costs of the plurality of pre-change points using a penalized cost function; and
minimizing the penalized cost function over the time series data; and
outputting the one or more change points.

2. The method of claim 1, wherein applying the Bayesian model to the time series data comprises determining respective Bayes factors for positions in the time series data.

3. The method of claim 2, wherein positions of the plurality of pre-change points are specified in a list, and wherein applying the Bayesian model to the time series data further comprises:
comparing the respective Bayes factors for the positions to a predefined threshold;
identifying a subset of the positions based on the comparison, wherein the positions in the subset have respective Bayes factors that exceed the predefined threshold;
designating the positions in the subset as pre-change points; and
adding the positions in the subset to the list.

4. The method of claim 3, wherein the predefined threshold is a customizable log odds threshold.

5. The method of claim 1, wherein:
the PELT model incorporates a Radial Basis Function (RBF) model;
applying the PELT model to the time series data and the plurality of pre-change points further comprises defining expected variations between data points in different segments of the time series data using the RBF model; and
the determination of the respective costs is based at least in part on the expected variations.

6. The method of claim 1, further comprising receiving a distribution type of the time series data, wherein the determination of the plurality of pre-change points is based at least in part on the distribution type.

7. The method of claim 1, further comprising receiving a penalty value, wherein the determination of the one or more change points from among the set of candidate change points is based at least in part on the penalty value.

8. The method of claim 1, wherein the time series data comprises pre-processed time series data which has undergone pre-processing to reduce noise in the time series data and remove outliers from the time series data.

9. The method of claim 1, further comprising:
receiving user input regarding the one or more change points; and
adjusting one or more parameters of the Bayesian model and/or the PELT model based on the user input.

10. The method of claim 9, wherein the user input comprises at least one of the following for a given change point of the one or more change points:
an indication to designate the given change point as a confirmed change point;
an indication to remove the given change point;
an indication to designate the given change point as a pending change point for further review; or
an indication to adjust a position of the given change point and designate the given change point as a modified change point.

11. The method of claim 10, further comprising:
storing the user input in a database; and
retrieving the user input in response to at least one of the following:
initiation of an update to the Bayesian model; or
initiation of an update to the PELT model.

12. A computing system, comprising:
at least one hardware processor;
at least one memory coupled to the at least one hardware processor;
a stored Bayesian model and a stored Pruned Exact Linear Time (PELT) model that incorporates a Radial Basis Function (RBF) model; and
one or more non-transitory computer-readable media having stored therein computer-executable instructions that, when executed by the computing system, cause the computing system to perform operations implementing a combined change-point analyzer for detecting performance regressions in a database system, the operations comprising:
receiving time series data representing performance test results for the database system;
determining a set of candidate change points comprising a plurality of pre-change points in the time series data by applying the Bayesian model to the time series data;
determining one or more change points from among the set of candidate change points by applying the PELT model to the time series data and the plurality of pre-change points; and
outputting the one or more change points.

13. The system of claim 12, further comprising a pre-processing module comprising computer-executable instructions that, when executed by the computing system, cause the computing system to perform operations comprising:
receiving raw time series data;
pre-processing the raw time series data, wherein the pre-processing of the raw time series data comprises reducing noise in the raw time series data and removing one or more outlier data points from the raw time series data; and
outputting the pre-processed raw time series data to the combined change-point analyzer as the time series data.

14. The system of claim 12, wherein the operations further comprise:
receiving user input regarding the one or more change points; and
adjusting one or more parameters of the Bayesian model, the PELT model, and/or the RBF model based on the user input.

15. The system of claim 14, wherein the user input comprises at least one of the following for a given change point of the one or more change points:
an indication to designate the given change point as a confirmed change point;
an indication to remove the given change point;
an indication to designate the given change point as a pending change point for further review; or
an indication to adjust a position of the given change point and designate the given change point as a modified change point.

16. The system of claim 14 further comprising a database, wherein the operations further comprise:
storing the user input in the database; and
retrieving the user input in response to at least one of the following:
initiation of an update to the Bayesian model;
initiation of an update to the PELT model; or
initiation of an update to the RBF model.

17. One or more non-transitory computer-readable media comprising computer-executable instructions that, when executed by a computing system, cause the computing system to perform operations implementing a combined change-point analyzer for detecting performance regressions in a database system, the operations comprising:
receiving time series data representing performance test results for the database system;
determining a set of candidate change points comprising a plurality of pre-change points in the time series data by applying a Bayesian model to the time series data;
determining one or more change points from among the set of candidate change points by applying a Pruned Exact Linear Time (PELT) model to the time series data and the plurality of pre-change points, wherein applying the PELT model to the time series data and the plurality of pre-change points comprises:
determining respective costs of the plurality of pre-change points using a penalized cost function; and
minimizing the penalized cost function over the time series data;
outputting the one or more change points;
receiving user input regarding the one or more change points; and
adjusting one or more parameters of the Bayesian model and/or the PELT model based on the user input.

18. The computer-readable media of claim 17, wherein the user input comprises one of the following for a given change point of the one or more change points:
an indication to designate the given change point as a confirmed change point;
an indication to remove the given change point;
an indication to designate the given change point as a pending change point for further review; or
an indication to adjust a position of the given change point and designate the given change point as a modified change point.

19. The computer-readable media of claim 17, wherein the operations further comprise:
storing the user input in a database; and
retrieving the user input in response to at least one of the following:
initiation of an update to the Bayesian model; or
initiation of an update to the PELT model.

20. The computer-readable media of claim 17, wherein the PELT model incorporates a Radial Basis Function (RBF) model, and wherein the operations further comprise:
adjusting one or more parameters of the RBF model based on the user input.
